(19) United States
(12) Patent Application Publication
(10) Pub. No.: US 2007/0024149 A1
(43) Pub. Date: Feb. 1, 2007

(54) Electric motor with split stator cores and semiconductor device connecting apparatus employing the motor

(75) Inventors: Masato Nagata, Kawasaki-shi (JP); Masahiro Kuroda, Yokkaichi-shi (JP); Akiyuki Yokoyama, Yokohama-shi (JP); Takanobu Kushihira, Yokohama-shi (JP); Tadahiro Nakayama, Yokohama-shi (JP); Tsuyoshi Shinohara, Yokohama-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/441,448

(22) Filed: May 26, 2006

(30) Foreign Application Priority Data
May 26, 2005 (JP) 2005-153897
Mar. 29, 2006 (JP) 2006-090674

(51) Int. Cl. H02K 1/06; H02K 1/28

(52) U.S. Cl. 310/217; 310/218; 310/259

(57) ABSTRACT

An electric motor includes a stator including a stator core made of a plurality of split cores joined to each other and a stator winding wound on the stator core, and an admixture interposed in a joint between the split cores and comprising a binder mixed with a granular magnetic substance.

### CROSS-REFERENCE TO RELATED APPLICATIONS

This application is based upon and claims the benefit of priority from the prior Japanese Patent Application Nos. 2005-153897 filed on May 26, 2005 and 2006-90674 filed on Mar. 29, 2006, the entire contents of which are incorporated herein by reference.

### BACKGROUND

1. Field of the Invention

The present disclosure relates to an electric motor including a stator core made by joining a plurality of split cores to one another, and more particularly to such a motor in which each split core comprises a number of steel plates stamped out and stacked, and a semiconductor connecting apparatus employing the above motor, such as a bonding apparatus.

2. Description of the Related Art

JP-A-2003-134702 discloses one of conventional electric motors of the above-described type. The disclosed motor includes a stator core enclosed in a housing and made by joining a plurality of split cores. Each split core is made by stacking a number of stamped steel plates.

FIG. 16 illustrates a stator core 3 constructed by joining annular tooth section 2 to an inner circumference of an annular yoke section 1 and a rotor 4 disposed at the inner circumferential side of the stator core 3. The rotor 4 includes a rotor core 5 and a plurality of permanent magnets 6 disposed on an outer circumference thereof. The yoke section 1 and tooth section 2 are made by stacking and uniting a number of stamped steel plates by caulking etc. The tooth section 2 includes a plurality of teeth 2a with root portions connected together. The yoke section 1 has a plurality of recesses 1a which are formed in an inner circumferential surface thereof so as to correspond to the teeth 2a respectively. In this case, each recess 1a and each tooth 2a have respective dimensional tolerances which are set so as to prevent distortion from occurring in a joint of each recess 1a and each tooth 2a.

On the other hand, outer surfaces of the yoke section 1 and tooth section 2 both made by stacking the stamped steel plates 7 and 8 actually have minute irregularities caused by dimensional errors, slippage during stacking or the like although being deemed smooth or planar macroscopically. Furthermore, provision of the aforesaid dimensional tolerances results in occurrence of small gaps 9 in a joint between the yoke section 1 and the tooth section 2 as shown in FIG. 17 which is an enlarged view of the joint of the split cores constituting a stator of a conventional motor. In FIG. 17, the small gaps 9 occur between a part of the steel plates 7 and 8 whereas the other steel plates 7 and 8 are adherent closely to each other.

In the above-described motor, a magnetic circuit is established so as to start from the north pole of the permanent magnet 6 and returning via the tooth section 2, yoke section 1 and tooth section 2 to the south pole of the permanent magnet 6. When the gaps 9 occur in the middle of the magnetic circuit, magnetic resistance is increased in the part of the gap 9 in the magnetic circuit. On the other hand, the magnetic resistance is small in the part where the steel plates 7 and 8 are adhered closely to each other. As a result, the magnetic resistance in the joint of the yoke section 1 and tooth section 2 varies in the axial and circumferential directions.

### SUMMARY

Therefore, an object of the disclosure is to provide an electric motor which comprises a plurality of split cores joined together into a stator core and can provide an improved magnetic circuit and a semiconductor connecting apparatus employing the above motor, such as a bonding apparatus.

In one aspect, the disclosure provides an electric motor comprising a stator including a stator core made of a plurality of split cores joined to each other and a stator winding wound on the stator core, and an admixture interposed in a joint between the split cores and comprising a binder mixed with a granular magnetic substance.

In the above-described construction, the admixture fills one or more gaps produced in each joint when the split cores are joined to each other. Accordingly, the magnetic resistance in the joint of the split cores is reduced and the magnetic resistance in the entire joint of the split cores is substantially uniformed. Consequently, effective magnetic flux of the field permanent magnet can be increased and accordingly, motor output can be increased.

In another aspect, the disclosure also provides a semiconductor connecting apparatus which connects a lead to an electrode of a semiconductor chip, comprising a bonding head movable upward and downward, and an electric motor for swinging the bonding head upward and downward, the motor comprising a stator including a stator core made of a plurality of split cores joined to each other and a stator winding wound on the stator core, and an admixture interposed in a joint between the split cores and comprising a binder mixed with a granular magnetic substance.

In the above-described construction, a swinging mechanism for the bonding head includes a swinging motor providing for substantially uniformed magnetic resistance. Consequently, an arm can smoothly be moved upward and downward and accordingly, semiconductor chips with uniformed product quality can be manufactured.

### BRIEF DESCRIPTION OF THE DRAWINGS

Other objects, features and advantages of the present disclosure on will become clear upon reviewing the following description of the embodiment with reference to the accompanying drawings, in which:

FIG. 1 is a longitudinally front view of an upper half of an electric motor of a first embodiment in accordance with the invention;

FIG. 2 is a plan view of a rotor and a stator and a rotor of the motor;

FIG. 3 is an enlarged view of a joint of split cores constituting the stator;

FIG. 4 is a graph showing comparison of electrical angle and magnetic field between the motor of the illustrative example and a conventional motor;

FIG. 5 is a view similar to FIG. 3, showing a second embodiment in accordance with the invention;

FIG. 6 is a view similar to FIG. 3, showing a third embodiment in accordance with the invention;

FIG. 7 is a perspective view of the split core;

FIG. 8 is an exploded perspective view showing the positional relationship between an assembling jig and nine split cores;

FIG. 9 is a perspective view of the split cores in an assembly step;

FIG. 10 is a graph showing changes in the cogging torque relative to rotational position of the motor;

FIG. 11 is a perspective view of a head of a bonding head 10;

FIG. 12 is a view similar to FIG. 6, showing a fifth embodiment in accordance with the invention;

FIG. 13 is a view similar to FIG. 6, showing a sixth embodiment in accordance with the invention;

FIG. 14 is a view similar to FIG. 6, showing a seventh embodiment in accordance with the invention;

FIG. 15 is a plan view of the stator, showing the positional relationship between an assembling jig and nine split cores;

FIG. 16 is a view similar to FIG. 2, showing a conventional construction; and

FIG. 17 is a view similar to FIG. 3, showing the conventional construction.

### DETAILED DESCRIPTION OF THE INVENTION

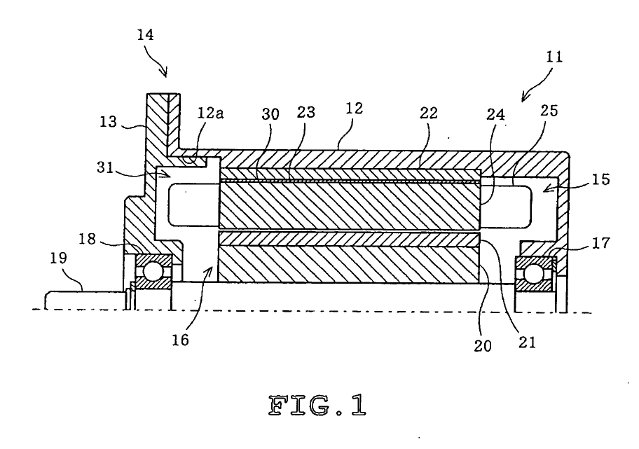

A first embodiment of the present invention will be described with reference to FIGS. 1 to 4. Referring to FIG. 1, an electric motor 11 of the embodiment is shown. The motor 11 comprises a housing 14 including a cylindrical frame 12 with a left opening 12a and a bracket 13 closing the opening 12a. A stator 15 and a rotor 16 are accommodated in the housing 14. Two bearings 17 and 18 are fixed to a right end face of the frame 12 and the bracket 13 respectively.

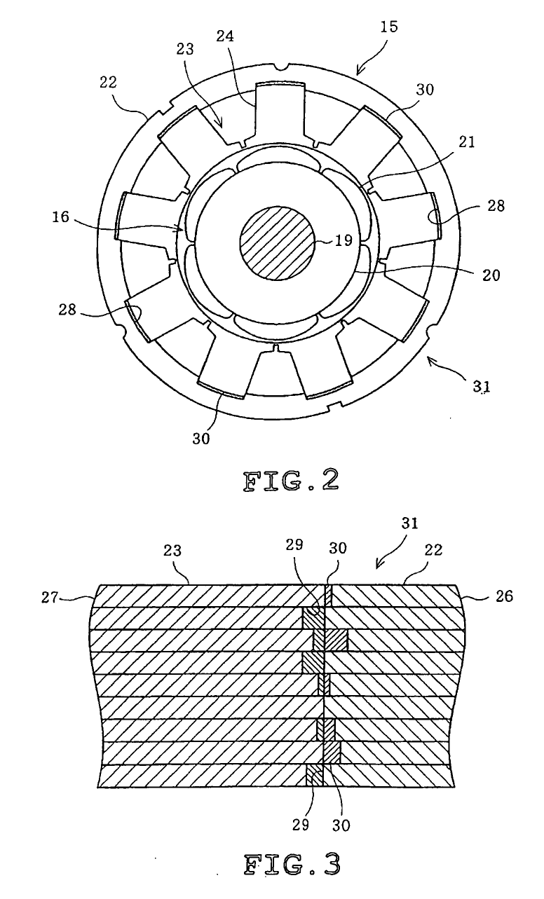

The rotor 16 comprises a rotor core 20 having a rotating shaft 19 supported on the bearings 17 and 18 and, for example, six field permanent magnets 21 disposed on an outer circumferential surface of the rotor core 20, as shown in FIGS. 1 and 2. North and south poles of the permanent magnets 21 are arranged alternately. On the other hand, the stator 15 comprises a stator core 31 and a stator winding 25 (shown only in FIG. 1). The stator core 31 includes an annular yoke section 22 (corresponding to a split core) fixed to an inner circumferential surface of the frame 12 and an annular tooth section 23 (corresponding to the split core) joined to an inner circumference. The tooth section 23 has a plurality of teeth 24 on which the stator winding 25 is wound. The rotor 16 is located inside the stator 15 and accordingly, the permanent magnets 21 of the rotor 16 are radially opposed to the tooth section 23 with a small gap therebetween.

The yoke section 22 and the tooth section 23 are each made by stacking a plurality of stamped steel plates 26 and 27 (shown only in FIG. 3). As a result, outer surfaces of the yoke section 22 and tooth section 23 have a number of minute irregularities caused by dimensional errors, slippage during stacking or the like. Accordingly, when the teeth 24 are force fitted into the convex portions 28 of the yoke section 22, gaps are produced in joints. In view of the problem, an admixture 30 is interposed in the joints between the yoke section 22 and the tooth section 23. The admixture 30 is comprised of fine grain of magnetic substance, such as iron powder, mixed with a resin binder.

A method of manufacturing the stator 15 will now be described. Firstly, the stator winding 25 is wound on the teeth 24 of the tooth section 23 and thereafter, the admixture 30 is applied to or sprayed onto at least one of the concave portions 28 and outer circumferential end faces of the teeth 24, thereby being formed into a thin film. Successively, the outer peripheral ends of the teeth 24 are force fitted into the concave portions 28 respectively using a forming jig (not shown). Thus, the teeth 24 are pressed against the concave portions 28 respectively such that the yoke section 22 and the tooth section 23 are joined to each other. In this case, as shown in FIG. 3, one or more gaps 29 produced in the joints are filled with the admixture 30.

In the motor 11 as described above, a magnetic circuit is established so that magnetic flux extends from the north pole of the permanent magnet 21 of the rotor 16 and returns through the tooth section 23 (teeth 24), yoke section 22 and tooth section 23 (teeth 24) to the south pole of the permanent magnet 21. In this case, the gaps 29 in the joints between the tooth section 23 and yoke section 23 are filled with the admixture 30 containing iron powder. This can suppress increase in the magnetic resistance in both axial and radial directions in the gaps 29. The axial direction refers to a direction in which the stamped steel plates 26 and 27 are stacked. Consequently, variations can be reduced in the magnetic resistance in the joint between the tooth section 23 and the yoke section 22.

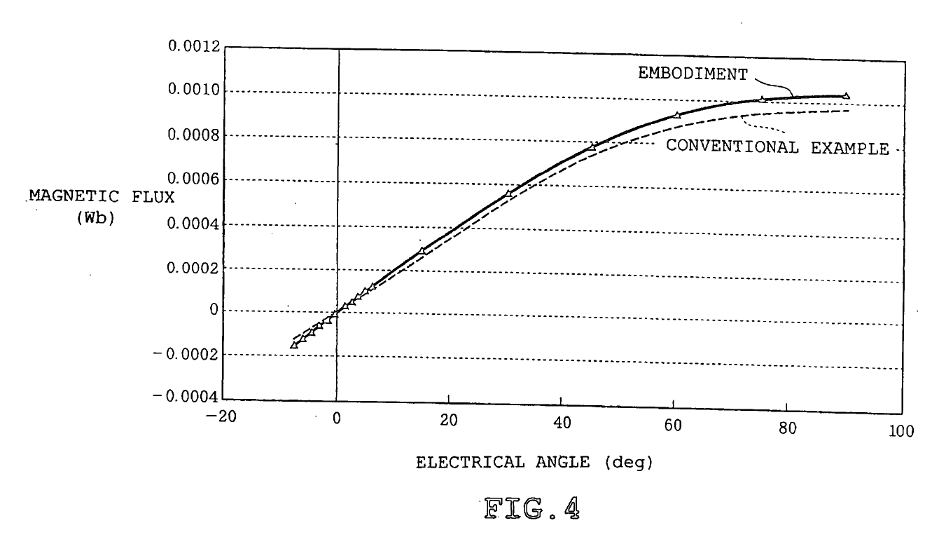

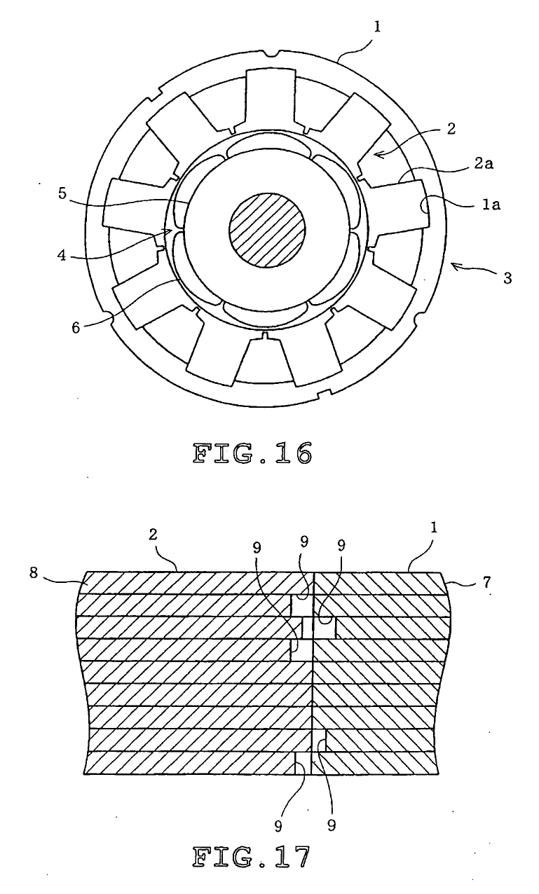

FIG. 4 is a graph showing comparison of output in terms of an amount of interlinked magnetic flux in the stator winding between a conventional motor (see FIGS. 16 and 17) and the motor 11 of the embodiment. An axis of abscissas in FIG. 4 designates an electrical angle (deg) and an axis of ordinates designates magnetic flux (Wb). As obvious from FIG. 4, an amount of interlinked magnetic flux of the motor 11 is larger by about 6% than an amount of interlinked magnetic flux of the conventional motor. As a result, output of the motor 11 is improved by about 6% as compared with output of the conventional motor. This can improve the motor efficiency, reduce power consumption and reduce the size of the motor 11.

Furthermore, the gaps in the joints between the tooth section 23 and the yoke section 22 are filled with the admixture 30. Consequently, variations can be reduced in the magnetic flux in the joint. This allows obtainment of induced voltage waveform with smaller amount of harmonic component and accordingly can render torque ripple smaller. Yet furthermore, since the magnetic resistance is reduced in the joint without dependence upon accuracy of the yoke section 23 and tooth section 22, the efficiency in the assembly of the yoke section 23 and tooth section 22 can be improved.

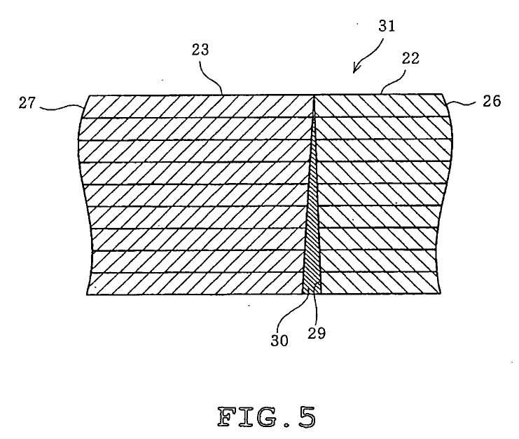

FIG. 5 illustrates a second embodiment of the invention. Only the difference of the second embodiment from the first embodiment will be described. The second embodiment is suitable for skewed steel plates of each split core. The second embodiment differs from the first embodiment in a method of manufacturing the stator core.

FIG. 5 shows obliquely stacked steel plates 27 of the tooth section 23. On the other hand, the steel plates 26 of the yoke section 22 are stacked substantially vertically. When the stamped steel plates 27 are obliquely stacked, the gap 29 in the joint between the tooth section 23 and the yoke section 22 is rendered gradually large from one end of the stacked steel plates to the other end of the stacked steel plates in the stacking direction (from the upper side to the lower side in FIG. 5).

The stator core 31 is manufactured as follows. Firstly, the admixture 30 is applied or sprayed onto the outer peripheral end of the tooth section 23 thereby to be formed into a thin film. The thin film is solidified by warm compaction. In this case, the thin film is solidified while the obliquely-stacked state of the steel plates is corrected. Successively, the stator winding 25 is wound on the tooth section 23 and thereafter, the tooth section 23 is force fitted into the concave portions 28. As a result, the admixture 30 can fill the gap 29 caused in the joint between the tooth section 23 and the yoke section 22 by obliquely stacking the steel plates 27. Thus, in the embodiment, too, the motor output and motor efficiency can be improved, whereupon the power consumption and the motor size can be reduced.

Furthermore, since the admixture 30 is solidified in the embodiment, the teeth 23 can easily be force fitted into the concave portions 28 respectively.

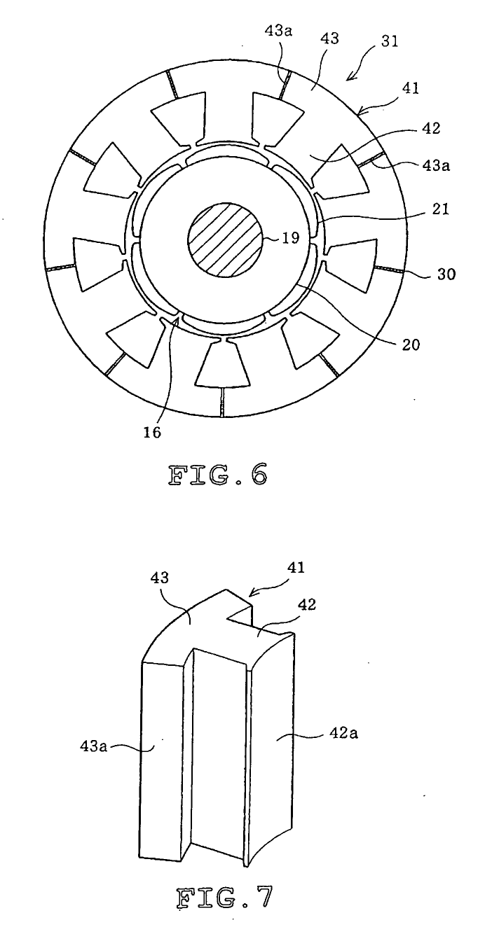

FIGS. 6 to 9 illustrate a third embodiment of the invention. Only the difference of the third embodiment from the first embodiment will be described. In the third embodiment, the stator core 31 comprises nine split cores 41 and the admixture 30, as shown in FIG. 6. The stator core 31 is divided circumferentially equally into nine parts corresponding to the split cores 41 respectively. Each split core 41 includes one tooth 42. Each split core 41 is made by stacking a plurality of stamped steel plates and binding the steel plates by crimping or the like. The split cores 41 are annularly disposed so that the teeth 42 are located at the inner circumferential side. The admixture 30 fills the gap in the joint between circumferential end faces 43a of the yoke 43 of the adjacent split cores 41. The stator 15 in the third embodiment comprises the stator core 31 and the stator winding 25 wound on each tooth 42 of the stator core 31.

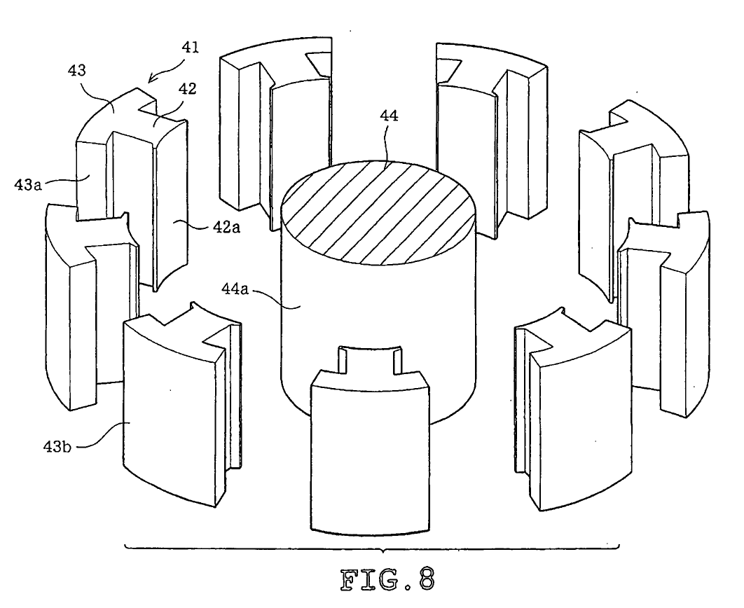

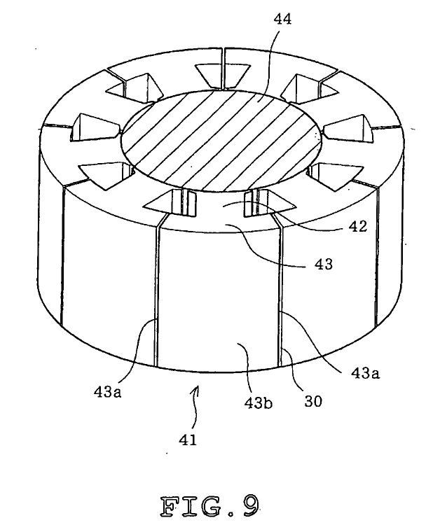

A method of manufacturing the stator 15 will be described with reference to FIGS. 8 and 9. FIG. 8 shows an assembling jig (forming jig) 44 and nine split cores 41. The assembling jig 44 is formed into a cylindrical shape with high circularity. The assembling jig 44 is constructed so as to be fitted in a cylindrical space defined by the inner peripheral end faces 42a of the nine teeth 42 when the split cores 41 are arranged cylindrically. In manufacturing the stator 15, firstly, the stator winding 25 is wound on each tooth 42 of the nine split cores 41. The admixture 30 is then applied or sprayed onto both end faces 43a of each split core 41 so that thin films of the admixture 30 are formed on the both end faces 43a of each split core 41. Successively, as shown in FIG. 9, the inner circumferential side end faces 42a of the teeth 42 of the nine split cores 41 are pressed against an outer circumferential surface of the assembling jig 44, whereupon the end faces 43a of the adjacent split cores 41 abut each other. Then, since the gap in the joint between the end faces 43a is filled with the admixture 30, no gap is defined between the end faces 43a of the adjacent split cores 41. When the admixture 30 is solidified in the filling state, the stator core 15 is completed.

According to the third embodiment, the gap in the joint between the adjacent split cores 41 is filled with the admixture 30, no axial or circumferential gaps are formed. Consequently, an increase in the magnetic resistance can be suppressed. Furthermore, the circularity of the stator 15 can be improved as the result of use of the assembling jig 44.

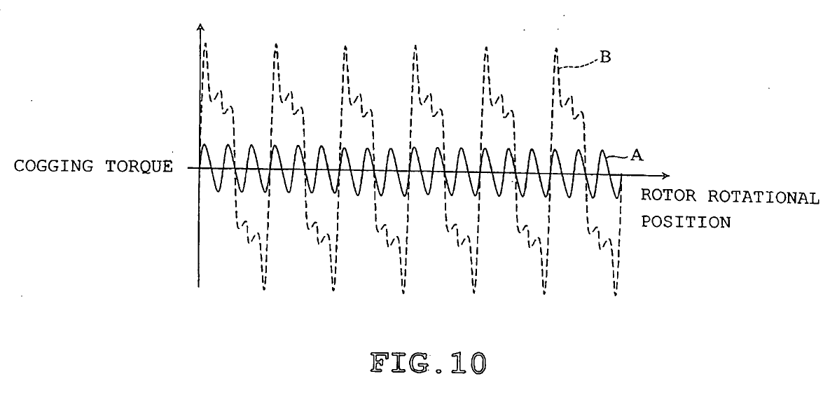

FIG. 10 shows a comparison of the characteristic of cogging torque between the motor (hereinafter, “embodiment product”) including the stator 15 manufactured using the assembling jig providing high circularity and a motor (hereinafter, “conventional product”) including a stator manufactured without use of the assembling jig 44 and the admixture 30. An axis of abscissas in FIG. 10 designates rotational angular position and an axis of ordinates designates cogging torque. Solid line A designates changes in the cogging torque of the embodiment product. Broken line B designates changes in the cogging torque of the conventional product. The stator 15 of the embodiment product has a high circularity and equal distances between the rotor 16 and the inner circumferential end faces 42a of the respective teeth 42 as shown in FIG. 10. Accordingly, the magnetic resistance can be rendered smaller and substantially uniformed in the embodiment product, whereupon the cogging torque can be reduced. On the other hand, since the stator of the conventional product has a low circularity, the magnetic resistance is rendered non-uniform, whereupon the cogging torque is increased.

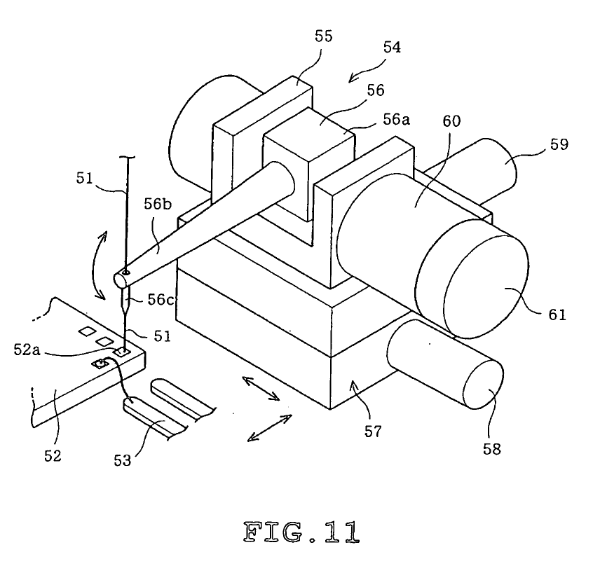

FIG. 11 illustrates a fourth embodiment of the invention. In the fourth embodiment, the embodiment product described in the third embodiment is employed in a semiconductor device connecting apparatus.

The semiconductor device connecting apparatus is provided for connecting a lead 53 to an electrode 52a of a semiconductor chip 52 using a bonding wire 51. FIG. 11 shows an appearance of a bonding head of the semiconductor device connecting apparatus. The bonding head 54 comprises a bonding head frame 55 and a swing arm 56 which is mounted on the frame so as to be vertically rotatable. The bonding head frame 55 is fixed to an X-Y table 57 which is controllable to be moved in X and Y directions on a horizontal plane. X-axis and Y-axis motors 58 and 59 are mounted on the X-Y table 57. The X-axis motor 58 moves the bonding head frame 55 in the X direction, whereas the Y-axis motor 59 moves the bonding head frame 55 in the Y direction.

A swing motor 60 is provided for vertically moving the swing arm 56. The swing motor 60 employs the stator 15 as shown in the third embodiment. The direction of energization to the stator winding 25 is reversed so that the swing arm 56 is vertically moved in a predetermined angular range. A rotational position of the swing motor 60 is detected by a position sensor 61. The swing arm 56 includes a holder 56a to which an arm 56b is fixed. The arm 56b has a distal end on which a bonding tool 56c is provided. The arm 56b and the bonding tool 56c have through holes (not shown) respectively. A bonding wire 51 is inserted through the holes of the arm 56b and the bonding tool 56c. The bonding wire 51 is joined to the electrode 52a of the semiconductor chip 52 and the lead 53 by the bonding tool 56c.

In describing the effects of the fourth embodiment, the swing motor 60 employing the stator 15 described in the third embodiment has a small and substantially uniform magnetic resistance and can accordingly reduce the cogging torque. Thus, since the swing motor 60 vertically moves the arm 56b smoothly, a bonding operation with high accuracy can be performed. Consequently, joint can be uniformed between the electrode 52a of the semiconductor chip 52 and the bonding wire 51 and between the lead 53 and the bonding wire 51, whereupon the quality of the semiconductor chips 52 can be uniformed.

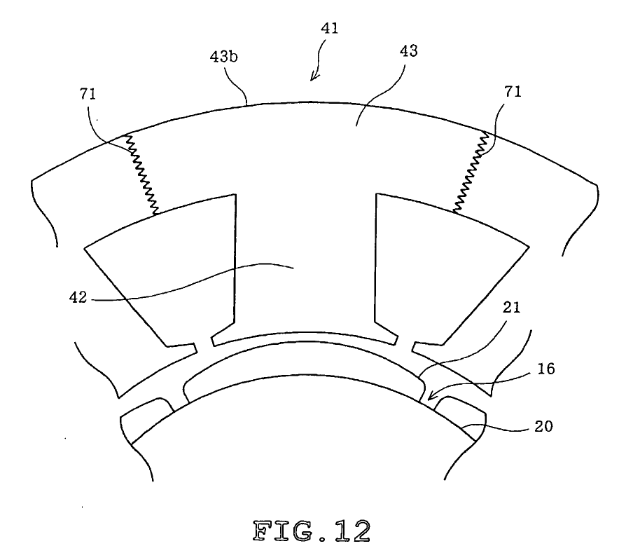

FIG. 12 illustrates a fifth embodiment of the invention. Differences of the fifth embodiment from the first embodiment will be described. Identical or similar parts in the fifth embodiment are labeled by the same reference symbols as those in the first embodiment.

The stator core 31 of the fifth embodiment has a plurality of small sawtooth irregularities 71 which are formed in both end faces 43a of each split core 41 so as to be brought into mesh engagement with the irregularities of each split core 41 to be joined to each other.

In the fifth embodiment, too, the stator 15 is manufactured using the assembling jig 44 as in the third embodiment. More specifically, the stator winding 25 is wound on each tooth 42, and the admixture 30 is applied or sprayed to both end faces 43a of each split core 41. Thereafter, the inner peripheral ends of nine teeth 42 are pressed against the outer circumferential face 44a of the assembling jig 44. As a result, the irregularities 71 of the adjacent split cores 41 are brought into mesh engagement with each other. In this state, pressure is applied to the split cores 41 at outer peripheral surface 43b, whereby the irregularities 71 are crushed such that joined portions of the split cores 41 are adhered closely to each other. Consequently, since the gaps between the split cores 41 are rendered as small as possible, the cogging torque can further be reduced.

FIG. 13 illustrates a sixth embodiment of the invention. Differences of the sixth embodiment from the third embodiment will be described. Each split core 41 has one end face 43a formed into a step-like convex portion 81 and the other end face 43a formed into a concave portion 82 capable of being fitted with the convex portion 81. The stator core 31 comprises a plurality of split cores 41 and the admixture filling the gaps in the fitted portions of the adjacent split cores 41. Furthermore, the convex and concave portions 81 and 82 are formed so that the stator core 31 has circularity when the convex portion 81 of each split core 41 is fitted with the concave portion 82 of the adjacent split core 41.

In describing the effects of the sixth embodiment, when the split cores 41 are joined to each other, the convex portion 81 of each split core 41 is fitted with the concave portion 82 of the adjacent split core 41. Consequently, the stator core with a high degree of circularity can easily be obtained.

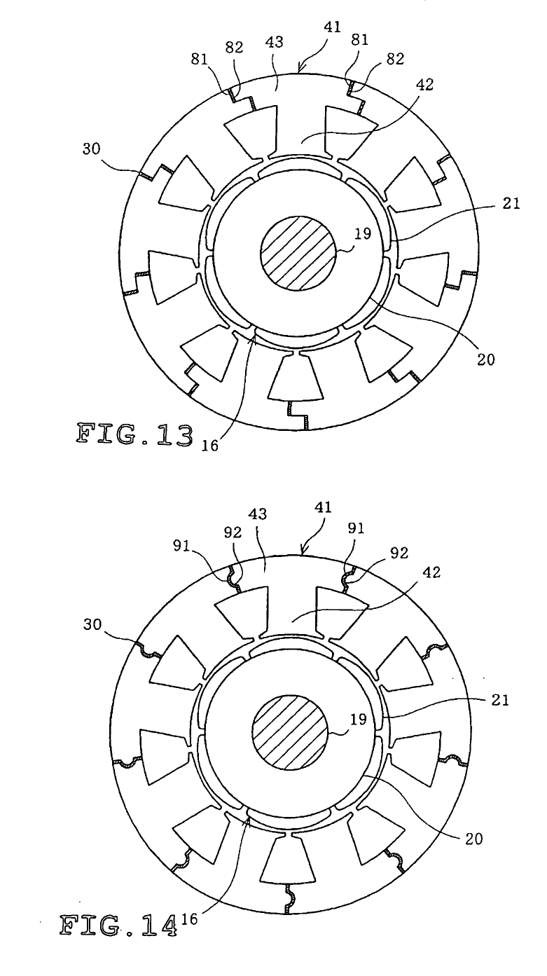

FIG. 14 illustrates a seventh embodiment of the invention. The seventh embodiment differs from the sixth embodiment in the following. One end face 43a of each split core 41 is formed with a semicircular convex portion 91, instead of the step-like convex portion 81 in the sixth embodiment. The other end face 43a of each split core 41 is formed with a semicircular concave portion 92 capable of being fitted with the convex portion 91.

In the seventh embodiment, too, the stator core 31 with a high degree of circularity can easily be obtained as in the sixth embodiment.

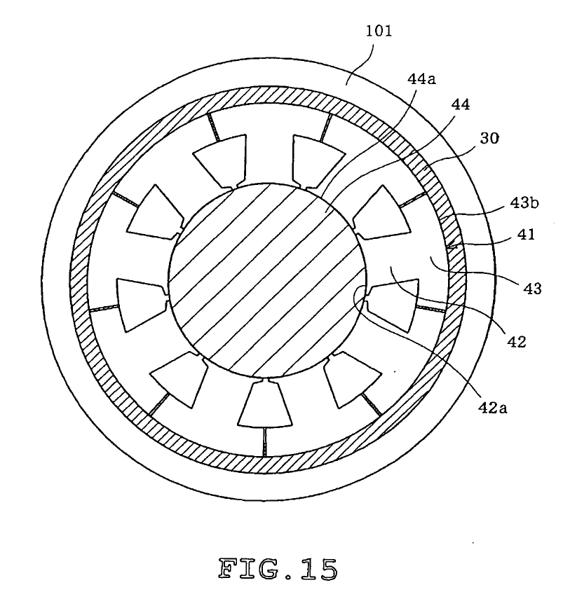

FIG. 15 illustrates an eighth embodiment of the invention. Differences of the eighth embodiment from the third embodiment will be described. The stator 15 of the eighth embodiment differs from the stator of the third embodiment in a manufacturing method. Firstly, a cylindrical assembling jig 44 is disposed in the central interior of a cylindrical forming die 101 so as to be concentric with the die 101. The stator winding 25 (see FIG. 1) is wound on the tooth 42 of each split core 41. Thereafter, the split cores 41 are annularly arranged in the space between the forming die 101 and the assembling jig 44 so that the inner peripheral end face 42a of the tooth 42 of each split core 41 abuts against the outer circumferential surface 44a of the assembling jig 44. The admixture 30 is then poured between the forming die 101 and the outer circumferential surfaces 43b of the yoke sections 43 of the split cores 41, being solidified.

The admixture 30 flows into gaps in each joint of the split cores 41. Accordingly, the magnetic resistance in each joint can be rendered smaller in the embodiment.

The invention should not be limited to the above-described embodiments but may be modified or expanded as follows. The stator core 31 is circumferentially divided into nine split cores 41 in each of the third to fifth and eighth embodiments. The number of split cores 41 should not be limited to nine. Two or more split cores may be used, instead.

In the fifth embodiment, the nine split cores 41 are pressed against the outer circumferential face 44a of the assembling jig 44 and thereafter, pressure is applied to the split cores 41 at the outer peripheral surfaces 43b. However, when the irregularities 71 of the adjacent split cores 41 are engaged with each other and a sufficiently adherent state is obtained from the engagement of the irregularities 71, the pressure applying step may be eliminated.

In the sixth and seventh embodiments, each end face 43a of each split core 41 is formed with one convex portion and one concave portion. However, each end face 43a may have two or more convex portions and two or more concave portions, instead.

The tooth section 23 and the yoke section 22 in each of the sixth and seventh embodiments may have sawtooth-like convex and concave portions 71, the step-like convex portion 81 and concave portion 82 or the semicircular convex portion 91 and concave portion 92.

The stator 15 in each of the sixth and seventh embodiments may be manufactured using the assembling jig 44 and the forming die 101 as shown in the third or eighth embodiment.

The motor 11 described in the first embodiment may be applied to the swing motor 60 of the semiconductor device connecting apparatus. Furthermore, the motor of each embodiment may be applied to each of the X-axis and Y-axis motors 58 and 59 of the semiconductor device connecting apparatus. According to this construction, the bonding head frame 55 can be moved with a high degree of accuracy.

The invention may be applied to outer rotor type motors, instead of the inner rotor type motor

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

What is claimed is:

1. An electric motor comprising:
a stator including a stator core made of a plurality of split cores joined to each other and a stator winding wound on the stator core; and
an admixture interposed in a joint between the split cores and comprising a binder mixed with fine grain of magnetic substance.

2. The motor according to claim 1, wherein the admixture is applied to the joint of each split core and thereafter, said each split core is joined to the other split core.

3. The motor according to claim 1, wherein the stator core comprise a tooth section and a yoke section.

4. The motor according to claim 1, wherein the split cores are obtained by dividing the stator core circumferentially.

5. The motor according to claim 1, wherein each split core includes a part to be joined to the other split core, said part being formed with a plurality of concave and convex portions, and the concave and convex portions of each one split core are brought into mesh engagement with the convex and concave portions of the other split core when the split cores are joined to each other.

6. The motor according to claim 5, wherein the split cores are joined to each other while being pressurized so that the concave and convex portions of the split cores in mesh engagement with each other are adhered closely to each other.

7. The motor according to claim 1, wherein the joint of each split core is formed with at least one concave or convex portion and the concave portion of each one split core is fitted with the convex portion of the other split core when the split cores have been joined to each other.

8. The motor according to claim 1, wherein the split cores are joined to each other using a forming jig.

9. The motor according to claim 4, wherein each split core has a tooth having an inner peripheral end face and wherein the split cores are disposed in an annular shape and thereafter the inner peripheral end faces of the teeth of each split core are abutted against a cylindrical assembly jig.

10. The motor according to claim 5, wherein the stator core is constituted by a plurality of split cores and includes a tooth section and a yoke section, and the stator core is constructed by disposing a cylindrical assembling jig in a cylindrical forming die so that the assembling jig is concentric with the forming die, annularly arranging the split cores in a space defined between the forming die and the assembling jig so that the inner peripheral end face of each tooth abuts against an outer circumferential surface of the assembling jig, and thereafter, pouring the admixture between the forming die and the yoke section of each split core and solidifying the admixture.

11. A semiconductor connecting apparatus which connects a lead to an electrode of a semiconductor chip, comprising:
a bonding head movable upward and downward; and
an electric motor for swinging the bonding head upward and downward, the motor comprising a stator including a stator core made of a plurality of split cores joined to each other and a stator winding wound on the stator core, and an admixture interposed in a joint between the split cores and comprising a binder mixed with a granular magnetic substance.

12. The connecting apparatus according to claim 11, wherein the admixture is applied to the joint of each split core and thereafter, said each split core is joined to the other split core.

13. The connecting apparatus according to claim 11, wherein the stator core comprise a tooth section and a yoke section.

14. The connecting apparatus according to claim 11, wherein the split cores are obtained by dividing the stator core circumferentially.

15. The connecting apparatus according to claim 11, wherein each split core includes a part to be joined to the other split core, said part being formed with a plurality of concave and convex portions, and the concave and convex portions of each one split core are brought into mesh engagement with the convex and concave portions of the other split core when the split cores are joined to each other.

16. The connecting apparatus according to claim 15, wherein the split cores are joined to each other while being pressurized so that the concave and convex portions of the split cores in mesh engagement with each other are adhered closely to each other.

17. The connecting apparatus according to claim 11, wherein the joint of each split core is formed with at least one concave or convex portion and the concave portion of each one split core is fitted with the convex portion of the other split core when the split cores have been joined to each other.

18. The connecting apparatus according to claim 11, wherein the split cores are joined to each other using a forming jig.

19. The connecting apparatus according to claim 14, wherein each split core has a tooth having an inner peripheral end face and wherein the split cores are disposed in an annular shape and thereafter the inner peripheral end faces of the teeth of each split core are abutted against a cylindrical assembly jig.

20. The connecting apparatus according to claim 15, wherein the stator core is constituted by a plurality of split cores and includes a tooth section and a yoke section, and the stator core is constructed by disposing a cylindrical assembling jig in a cylindrical forming die so that the assembling jig is concentric with the forming die, annularly arranging the split cores in a space defined between the forming die and the assembling jig so that the inner peripheral end face of each tooth abuts against an outer circumferential surface of the assembling jig, and thereafter, pouring the admixture between the forming die and the yoke section of each split core and solidifying the admixture.
